(19) United States
(12) Patent Application Publication
(10) Pub. No.: US 2010/0154608 A1
(43) Pub. Date: Jun. 24, 2010

(54) Method and device for obtaining longitudinal pieces

(76) Inventors: Yolanda Miguez Charines, Madrid (ES); Julian Sanchez Fernandez, Madrid (ES); Mauricio Sanchez De La O, Madrid (ES)

Correspondence Address: KLAUBER & JACKSON, 411 HACKENSACK AVENUE, HACKENSACK, NJ, 07601, US

(21) Appl. No.: 12/386,670

(22) Filed: Apr. 21, 2009

(30) Foreign Application Priority Data
Dec. 23, 2008 (ES) P200803668

(51) Int. Cl. B26D 7/18; B26D 7/01

(52) U.S. Cl. 83/23; 83/100; 83/156

(57) ABSTRACT

In the state of the art, a composite prepreg lamination (2) is obtained, arranged on a cutting table (1), the lamination being affix to the table (1) by means of applying a vacuum, and the cutting of the lamination (2) being done in longitudinal strips (3) between which remain wasting material strips (4), being manually removed in order to continue with the subsequent post-processing of the longitudinal strips (3) and obtain the longitudinal pieces.

The aim of the invention is to automate the process of removing the wasting material strips (4) so that, prior to their removal, one end (4a) of the strips (4) is affix on a rolled up device (5) and the strips (4) are rolled up in the longitudinal direction of the lamination (2).

The device basically comprises a roller (5) provided with means for affixing the ends (4a) of the strips (4) for carrying out the said automation.

### OBJECT OF THE INVENTION

The invention relates to a method and device allowing longitudinal pieces to be obtained starting from a lamination in which longitudinal cuts are made in order to obtain the longitudinal pieces, between which there remain wasting material strips; and which has the aim of permitting the removal process of the wasting material strips to be automated.

The invention is applicable to any sector of industry in which it is required to obtain longitudinal pieces starting from a lamination, and more specifically it is applied in the aeronautical industry for obtaining longitudinal pieces starting from a lamination of a composite prepreg material, as is for example the case of stringers which are conventionally used in the aeronautical industry as stiffening elements for fuselage sections or as stiffening elements for the lifting surfaces of aircraft.

### BACKGROUND OF THE INVENTION

The obtaining of longitudinal pieces, in other words those with a predominant extension along a longitudinal direction, and which present a narrow thickness, is known in the state of the art, as is the case of stringers which are conventionally used as stiffening elements in the aeronautical industry, and which are obtained starting from a lamination in which each one of the layers comprises a composite prepreg material defined by reinforcement fibers preimpregnated in a resin matrix, in which the fibers are continuously aligned along each layer.

To achieve this, the different layers of composite prepreg material are spread stacked on the surface of a mold which is made by means of an automatic taping process in which, by means of a head fed with a prepreg tape, each one of the layers is arranged on the surface of the mold and duly compacted.

The obtained lamination is then arranged on a cutting table in which the lamination is cut into longitudinal strips, for which purpose a film of plastic is placed on the lamination and a vacuum is applied from inside the cutting table between it and the plastic film, which permits proper affixing of the lamination so that it can be cut in such a way that it does not become displaced during this operation.

When effecting the cutting, some strips of wasting material are produced between the longitudinal strips, and these wasting material strips are then removed manually by an operator, thus hindering this process on account of the force required to be applied in order to tear away the wasting material strips from the longitudinal strips that have been obtained, additionally, the fact that the wasting material strips represent a weight that becomes greater as more and more of it is torn away, requiring a greater effort from the operator. Moreover, the manual tearing away of the wasting material strips is not done in a precise manner, and this can cause the longitudinal strips that are being obtained to suffer manufacturing defects such as creases or irregular cuts in their edges.

Furthermore, this manual process takes an excessive amount of time for removing the wasting material strips.

It is consequently desirable to automate the process of removing the wasting material strips, which considerably simplifies the process of obtaining the longitudinal pieces.

As information, it is to be mentioned that once the longitudinal strips have been obtained, a post-processing is then carried out in order to obtain the final longitudinal piece. The post-processing comprises thermoforming by the application of temperature and pressure, then carrying out a curing until the resin solidifies, for instance: a later cocuring with another piece of composite material until the unit solidifies, or a secondary cobonding to stick the finished piece to another finished piece, or cobonding one piece of fresh composite material to another piece of cured composite material, etc., depending on the application to which the longitudinal piece that is obtained is destined, such as might be for example “T” or “omega” stringers, rib stays, etc.

### DESCRIPTION OF THE INVENTION

In order to achieve the above-mentioned automation, the invention provides a new method of obtaining longitudinal pieces, which, as with the conventional method, comprises obtaining a lamination of composite prepreg material, arranging the lamination on a cutting table, affixing the lamination to the table by means of applying a vacuum thereon, cutting the lamination into longitudinal strips between which there remain wasting material strips, removing the wasting material strips and carrying out the later post-processing of the longitudinal strips obtained from the lamination in order to obtain the longitudinal pieces, and it presents the novelty that, prior to the removal of the wasting material strips, it comprises a step of affixing the ends of the wasting material strips in a rolled up device, which is followed by a step in which the wasting material strips are rolled up in the longitudinal direction of the lamination.

In the preferred embodiment of the invention, the cuts are made in such a way that the wasting material strips have no discontinuity, though in the event that the wasting material strips do present discontinuities forming different sections, the said method is carried out for rolling the wasting material strips of a first section up to the first discontinuity and then the ends of the following section of wasting material strips, starting from the first discontinuity, are affixed in the rolling up device in order to carry out the rolling up of the new section of wasting material strips, repeating the process successively until all the wasting material strips have been completed.

The invention further relates to the device that permits the above steps to be carried out, device which is characterized in that it comprises a roller fitted with means for affixing the ends of the wasting material strips, and means for angular displacement and movement of the roller with respect to the composite lamination, in order to carry out the rolling up of the wasting material strips and separate them from the longitudinal strips.

In an embodiment of the invention, the means for affixing the ends of the wasting material strips in the roller are defined by pinching elements that facilitate the securing of the ends of the wasting material strips.

Moreover, the device of the invention comprises elements for pressing the ends of the longitudinal strips that have been obtained, in order to facilitate the separation of the wasting material strips from the longitudinal strips at the start of the rolling.

In an embodiment of the invention, the displacement movement of the roller on the wasting material strips is effected along rails conventionally incorporated by the cutting machine.

Furthermore, in an embodiment of the invention the roller is fitted with a replaceable outer sheath in which the rolling of the wasting material strips is performed, in such a way that, when carrying out the extraction of the sheath the removal of the wasting material strips is produced. The replaceable sheath can be disposable, leading to greater facility and speed in disposing of the wasting material strips.

In an embodiment of the invention, the device comprises means for keeping the roller in contact with the lamination during the rolling up process, though this operation can also be carried out with the roller separated a certain distance from the lamination during the rolling.

Below, in order to facilitate a better understanding of this descriptive specification and forming an integral part thereof, a series of figures are attached in which, by way of illustration and non-limiting, the object of the invention has been represented.

### BRIEF DESCRIPTION OF THE FIGURES

FIG. 1.—Shows a schematic view of a lamination already cut on the cutting table, in which the rolled up device of the invention is included.

FIG. 2.—Shows a schematic representation of the detail of the securing of the end of the wasting material strip in the roller in order to carry out the rolling up and extraction of the wasting material strips.

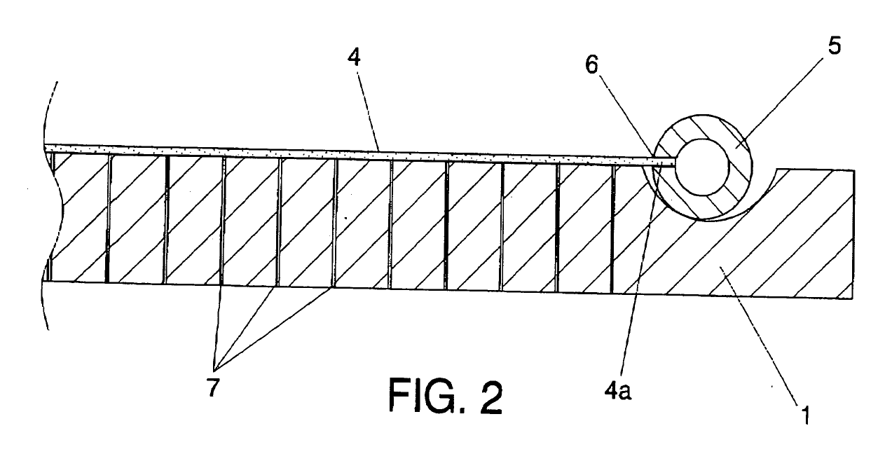

FIG. 3.—Shows an equivalent view to FIG. 1, but in this case the rolling up of the wasting material strips has commenced.

### DESCRIPTION OF THE PREFERRED FORM OF EMBODIMENT

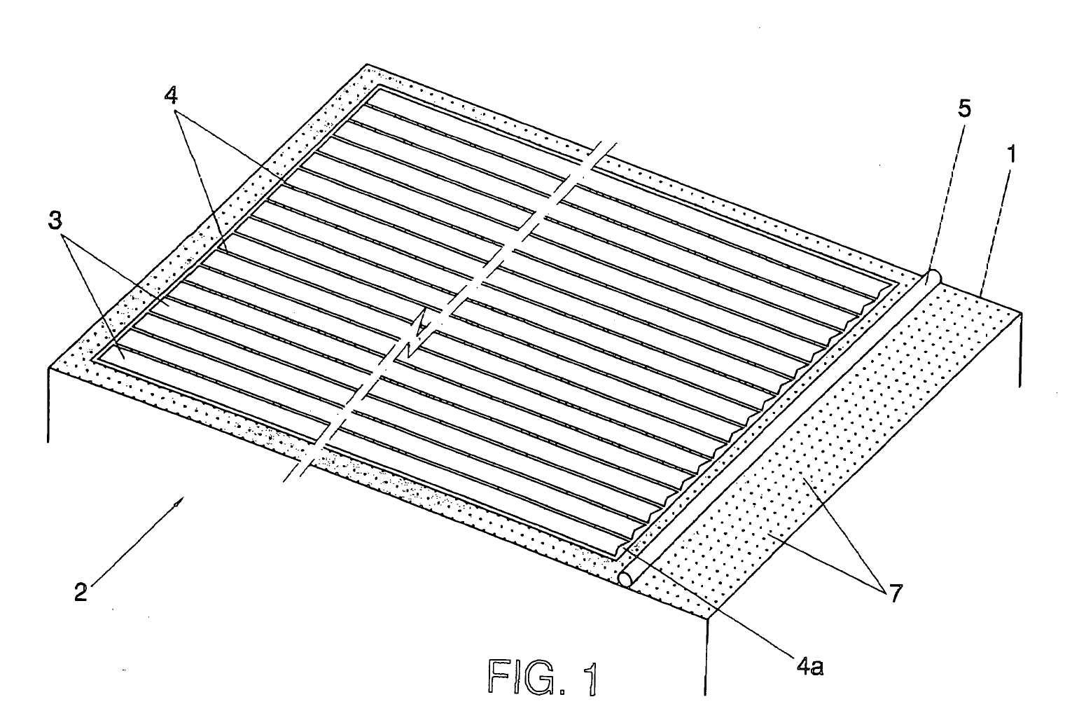

As provided in the state of the art, and as already described, the method for obtaining longitudinal pieces of the invention comprises obtaining a lamination 2 in which each of the layers consists of composite prepreg material, in such a way that the lamination is arranged on a cutting table 1 in which the lamination 2 is affixed by means of applying a vacuum from the inside of the table, which, via some holes 7, produces suction of the lamination 2 leaving the latter perfectly affixed to the cutting table 1 for carrying out the cutting of the lamination into longitudinal strips 3. This cutting operation results in the production of wasting material strips 4 between the longitudinal strips, as shown in FIG. 1, which have to be removed in order to obtain the final longitudinal pieces which are obtained from the longitudinal strips 3, by means of the later post-processing of them, as already mentioned in the background of the invention section.

The cutting carried out results in all the wasting material strips 4 remaining attached by at least one of their ends via a fringe 4a.

The method of the invention incorporates the novelty of automating the removal of the wasting material strips 4, for which a step is provided, prior to the removal of the wasting material strips, comprising fixing the fringe 4a joining the ends of said wasting material strips 4 in a rolling device and effecting the later rolling of the wasting material strips 4 in the longitudinal direction of the lamination 2 in order to carry out the removal of the wasting material strips 4, in such a way that their removal process is automated and the obtaining of the longitudinal pieces is simplified.

In order to carry out the described method, the invention also relates to a device comprising a roller 5 which is fitted with means 6 for fixing the ends 4a of the wasting material strips 4, these means consisting in the example of embodiment of a slot made in the roller 5 in which the fringe 4a joining the end of the wasting material strips 4 is inserted and retained. This retention, for example, is materialized by means of a pinching element, not represented in the figures.

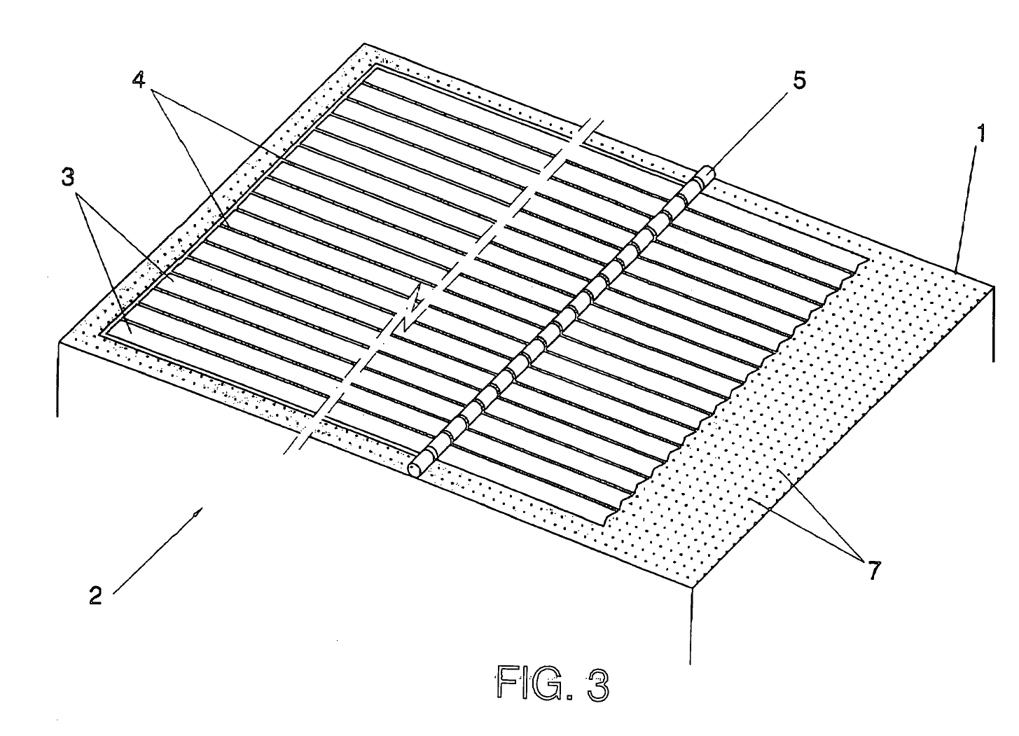

This configuration means that, with the longitudinal strips 3 being kept secured on the cutting table 1, applying the already mentioned vacuum, and carrying out the angular displacement and movement of the roller with respect to the longitudinal strips 3, the rolling up takes place of the wasting material strips 4 on the roller 5, as shown in FIG. 3, which, on reaching the other end of the longitudinal strips, permits the complete removal of the wasting material strips 4 to be produced, the longitudinal strips 3 remaining in a state for being able to carry out the later post-processing starting from which the longitudinal pieces are obtained.

Moreover, the roller 5 can be fitted with a replaceable and/or disposable sheath, not represented, which facilitates the extraction of the wasting material strips 4 in different laminations 2 consecutively in a minimum time.

As example, it can be mentioned that the thickness of the lamination 2 can lie between 2.8 mm and 9.6 mm. A lamination 2 of fourteen layers typically has a thickness of 2.8 mm.

The cutting table 1 presents dimensions of 20 m×3 m, and the lamina 2 can have up to those dimensions, therefore the length of the wasting material strips 4 can be up to 20 m, though it is possible to increase these measurements.

1. METHOD AND DEVICE FOR OBTAINING LONGITUDINAL PIECES, which comprises
obtaining a composite prepreg lamination (2),
arranging the lamination (2) on a cutting table (1),
affixing the lamination (2) to the table (1) by means of applying a vacuum to said table (1),
cutting the lamination (2) into longitudinal strips (3) between which there remain wasting material strips (4),
removing the wasting material strips (4) and
carrying out a post-processing of the longitudinal strips (3) in order to obtain the longitudinal pieces;
wherein prior to the removal of the wasting material strips (4) it comprises affixing one end (4a) of the wasting material strips (4) in a rolled up device and rolling up the wasting material strips (4) in the longitudinal direction of the lamination (2).

2. METHOD AND DEVICE FOR OBTAINING LONGITUDINAL PIECES, according to claim 1, wherein in the event that the wasting material strips (4) present discontinuities forming different sections, and after carrying out the rolling up of the wasting material strips (4) of a first section up to a first discontinuity, it comprises affixing the ends of the next section of wasting material strips (4) in the rolled up device, starting from the first discontinuity, and rolling up the new section of wasting material strips, and so on successively until all the sections forming the wasting material strips have been completed.

3. METHOD AND DEVICE FOR OBTAINING LONGITUDINAL PIECES, according to claim 1, wherein the longitudinal pieces are aeronautical pieces.

4. DEVICE FOR OBTAINING LONGITUDINAL PIECES, obtained starting from a composite prepreg lamination (2) which is arranged on a cutting table (1) on which a vacuum is applied for affixing the lamination (2) and cutting it into longitudinal strips (3) between which there remain wasting material strips (4); wherein it comprises a roller (5) provided with means for affixing (6) the ends (4a) of the wasting material strips (4), and means for angular displacement and movement of the roller (5) with respect to the composite material lamination (2), in order to carry out rolling up of the wasting material strips (4) and separate them from the longitudinal strips (3).

5. DEVICE FOR OBTAINING LONGITUDINAL PIECES, according to claim 4, wherein the means for affixing of the ends (4a) of the wasting material strips (4) in the roller (5) are defined by pinching elements.

6. DEVICE FOR OBTAINING LONGITUDINAL PIECES, according to claim 4, wherein it comprises elements for pressing the ends of the longitudinal strips (3) in order to facilitate the separation of the wasting material strips (4) from the longitudinal strips (3) at the start of the rolling up.

7. DEVICE FOR OBTAINING LONGITUDINAL PIECES, according to claim 4, wherein the roller (5) is displaced along some rails of the cutting machine (1).

8. DEVICE FOR OBTAINING LONGITUDINAL PIECES, according to claim 4, wherein the roller (5) comprises a replaceable outer sheath in which the rolling up of the wasting material strips is carried out.

9. DEVICE FOR OBTAINING LONGITUDINAL PIECES, according to claim 8, wherein the replaceable outer sheath is disposable.

10. DEVICE FOR OBTAINING LONGITUDINAL PIECES, according to claim 4, wherein it comprises means for keeping the roller (5) in contact with the lamination (2) during the rolling up.
